(19) United States
(12) Patent Application Publication
(10) Pub. No.: US 2009/0117978 A1
(43) Pub. Date: May 7, 2009

(54) METHOD OF GAMING, A GAMING SYSTEM AND A GAME CONTROLLER

(75) Inventor: Claudio Daniel Dias Pires, Bonnyrigg Heights (AU)

Correspondence Address: MCANDREWS HELD & MALLOY, LTD, 500 WEST MADISON STREET, SUITE 3400, CHICAGO, IL, 60661, US

(73) Assignee: Aristocrat Technologies Australia Pty Limited, Lane Cove (AU)

(21) Appl. No.: 12/129,349

(22) Filed: May 29, 2008

(30) Foreign Application Priority Data
May 30, 2007 (AU) 2007902894

(51) Int. Cl. A63F 9/24; A63F 13/00

(52) U.S. Cl. 463/20

(57) ABSTRACT

In a gaming system, an initial set of symbols comprise symbols of a plurality of groups and are displayed in respective ones of display positions. A revised set of symbols is formed by modifying the display position of symbols of at least one of the groups that are formed. In one example, each group of symbols is selected from a set representing a reel of symbols. The reel of symbols is provided in a given order drawn on a physical looped reel. One or more symbols from each reel may be selected for display in accordance with a symbol selection algorithm. A game outcome may be determined based on the relative position of symbols within the revised set.

### FIELD OF THE INVENTION

The present invention relates to a method of gaming, a gaming system and a game controller.

### BACKGROUND TO THE INVENTION

It is known to provide a gaming system including a gaming controller arranged to randomly select symbols for display from a predetermined set of symbols and determine a game outcome based on the displayed symbols. Such gaming systems are often implemented as a video gaming machine wherein the selected symbols are displayed on a video display. The symbols can be displayed on virtual reels.

There is a need for an alternative game in order to maintain or increase player interest and enjoyment.

### SUMMARY OF THE INVENTION

In the first aspect, there is disclosed a method of gaming comprising:
displaying an initial set of symbols comprising symbols of a plurality of groups in respective ones of display positions; and
forming a revised set of symbols by modifying the display position of symbols of at least one group relative to at least one other group of the plurality of groups.

In an embodiment each group of symbols is selected from a predetermined set of symbols representing a reel of symbols. A reel of symbols is representative of symbols in a given order drawn on a physical looped reel, however, in an embodiment each reel is implemented in software as a virtual reel of symbols. In this embodiment one or more symbols from each reel are selected for display based on symbol selection algorithm. The symbol selection algorithm can imitate displaying one or more consecutive symbols based on a stop position of each reel.

The method can further comprise the step of determining a game outcome based on the relative position of symbols within the revised set of symbols.

An embodiment further comprises the step of forming a further revised set by modifying the display position of a further group relative to at least one other group of the plurality of groups.

In an embodiment the step of forming further revised sets is repeated until an end condition is met.

The above method can further comprise a step of determining a game outcome based on relative positions of symbols within each further revised set of symbols.

An alternative embodiment further comprises the step of forming a further revised set by altering the symbols displayed within one group.

In an embodiment altering of the symbols displayed in one group can comprise incrementally shifting the symbol display position of symbols within the group such that one symbol ceases to be displayed at one end of a group display area and a further symbol is selected and displayed at an opposing end of the group display area.

An alternative embodiment of the method further comprises the steps of:
holding at least one group of symbols such that the symbols selected for display do not change; and
forming a further revised set of symbols by re-selecting symbols for the remaining groups.

In an embodiment the held group of symbols is the group in the modified display position.

In an alternative embodiment the set of symbols may include a special function symbol provided with a special function. For example, the function symbol may be arranged to remain in a fixed position when a further revised set is formed. Alternatively the special symbol can be associated with a group and change display position with the group.

The above embodiments can also comprise the step of determining a game outcome based on the initial set of symbols.

In an embodiment of the invention modifying the display position of symbols comprises a swap where the display position of one group of symbols is swapped with the display position of another group of symbols.

In an alternative embodiment modifying the display position of one group of symbols comprises a shuffle, where altering the position of one group of symbols from a first position to a second position causes a subsequent shift by one display position of each group of symbols displayed between the first and second display positions.

In one embodiment the group of symbols to have a modified display position can be selected by the game player.

In some embodiments the player can also select the modified display position of the selected group.

In another embodiment the modified display position of the selected group is determined by a game controller.

The modified display position may be selected randomly or based on pre-determined game rules.

In other embodiments, groups to modify display positions for are selected by a game controller.

The groups to modify display positions for may be predetermined, randomly selected or based on pre-defined game rules.

The number of groups allowed to be modified can be predetermined, randomly selected or based on game rules.

In an embodiment the group display position modifications can be made until an end condition is met.

In some embodiments of the invention eligibility for modifying a group display position for a game is based on eligibility criteria.

In one embodiment eligibility criteria is based on game rules.

In another embodiment eligibility is based on player activity.

An embodiment can be implemented using physical spinning reels, where modifying the display position of a group comprises mechanical movement of one or more reels.

In a second aspect there is disclosed a gaming system comprising:
a display;
a symbol selector arranged to select an initial set of symbols comprising symbols of a plurality of groups for display in respective ones of a plurality of group display positions;
a group position modifier arranged to modify the group display positions of one or more groups to form a revised set of symbols for display; and
a display controller arranged to cause the display to display the initial set and revised set of symbols based on group display positions.

In an embodiment, the gaming system further comprises an outcome generator arranged to determine a game outcome based on the revised set of symbols.

In a third aspect there is disclosed a game controller comprising:
a symbol selector arranged to select an initial set of symbols comprising symbols of a plurality of groups for display in respective ones of a plurality of group display positions;
a group position modifier arranged to modify the group display positions of one or more groups to form a revised set of symbols for display; and
a display controller arranged to cause the display to display the initial set and revised set of symbols based on group display positions.

In an embodiment the game controller further comprises an outcome generator arranged to determine a game outcome based on the revised set of symbols.

In a fourth aspect computer program code is provided which when executed causes a computer to implement a computer implemented gaming method comprising:
displaying an initial set of symbols comprising symbols of a plurality of groups in respective ones of display positions; and

forming a revised set of symbols by modifying the display position of symbols of at least one group relative to at least one other group of the plurality of groups.

The gaming system may be implemented as a stand alone gaming machine or across a network.

### BRIEF DESCRIPTION OF THE DRAWINGS

An exemplary embodiment of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of a gaming system;

FIG. 7 is a flowchart of an embodiment of a game process;

FIGS. 8a and 8b show exemplary displays of a first example;

FIGS. 9a and 9b show exemplary displays of a second example;

FIGS. 10a and 10b show exemplary displays of a third example; and

FIGS. 11a to 11f show exemplary displays of a fourth example.

### DETAILED DESCRIPTION

Referring to the drawings, there is shown a gaming system arranged to implement a game with a group display position modification, such as a game where at least one reel is moved relative to the other reels. The gaming system can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

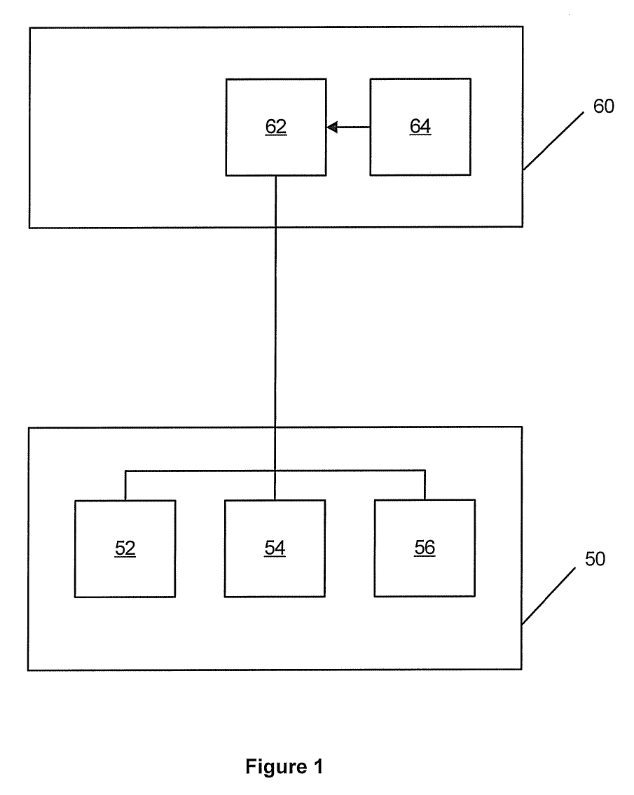

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

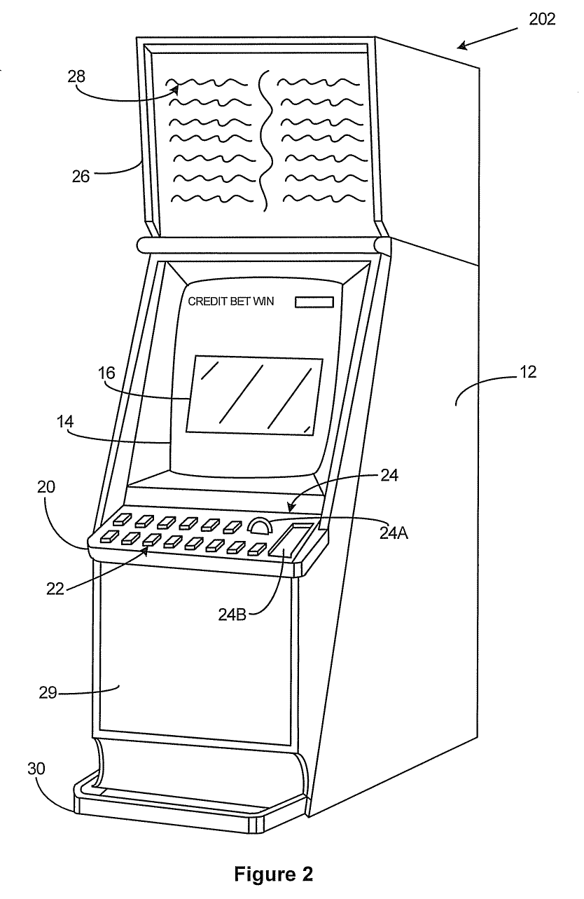

A gaming system in the form of a stand alone gaming machine 202 is illustrated in FIG. 2. The gaming machine 202 includes a console 12 having a display 14 on which is displayed representations of a game 16 that can be played by a player. A mid-trim 20 of the gaming machine 202 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 202.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

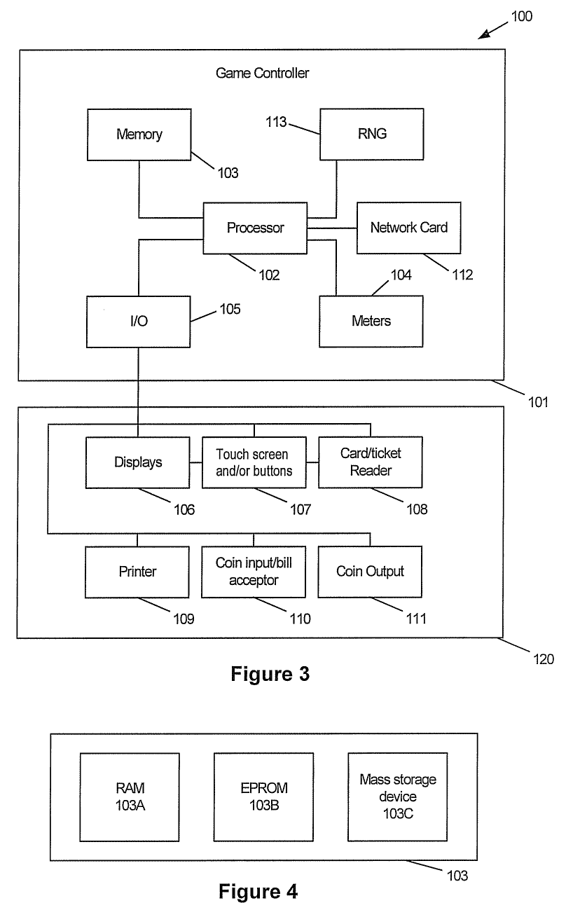

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 202,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. In a thick client embodiment one or more further optional servers 212 may also be provided for controlling further functions, such as monitoring functions, the number of servers provided in the system can vary depending on requirements to implement the system functionality.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

Gaming systems for implementing games that involve a display of spinning reels as part of the display of the outcome of a game have either a video display or a mechanical display, these later machines most usually being “stepper” machines which have a separate motor for each reel.

The game controllers of such gaming machines have a stop determining function that determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position.

Embodiments of the present invention relate to gaming systems that allow a player to select how many win lines of a plurality of win lines they will play in each game—i.e. a minimum of one win line up to the maximum number of win lines allowed by the game. Each win line is formed by a set of symbol positions consisting of one symbol position from each group, for example a group can represent one reel. That is, a predetermined symbol position of each group is assigned to a win line. The symbol positions that constitute each of the win lines are usually advertised to the player by markings on the display or diagrams showing the symbol positions that correspond to each win line. Some of the win lines will be horizontal or diagonal lines but others may be non-linear combinations of symbols. Typically, the win lines will be constituted by symbol positions in the visible window.

The gaming system implements a game where the display position of one or more groups of a set of displayed symbols can be modified to provide a revised set of displayed symbols. An embodiment of the gaming system will normally implement the game as a “feature”. For example the feature becomes available once eligibility criteria are met. In one variation during the feature, a series of games are played during which a group can be modified. The feature games may be repeated a number of times until an end condition is met. For example, an end condition may be that the display position for an allowed number of groups has been modified.

Modifying the display position of one or more of the groups alters the displayed relative symbol positions and hence alters the possibility of prize winning symbol combinations occurring for a set of selected symbols. It should be appreciated that in some embodiments the selected symbol set does not change, only the displayed symbol positions. Thus, modifying the display position of one or more groups can alter the game outcome without altering the selected symbols.

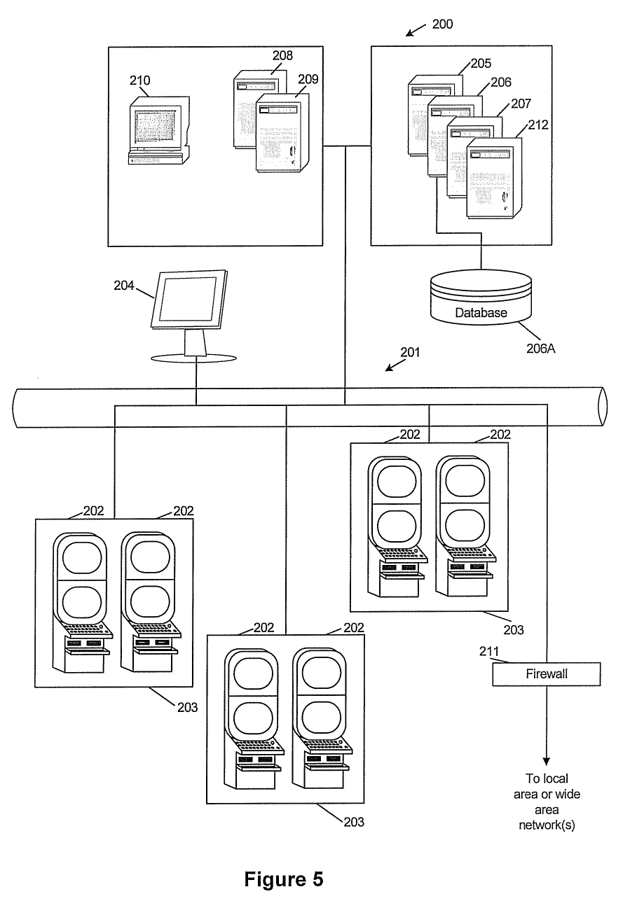

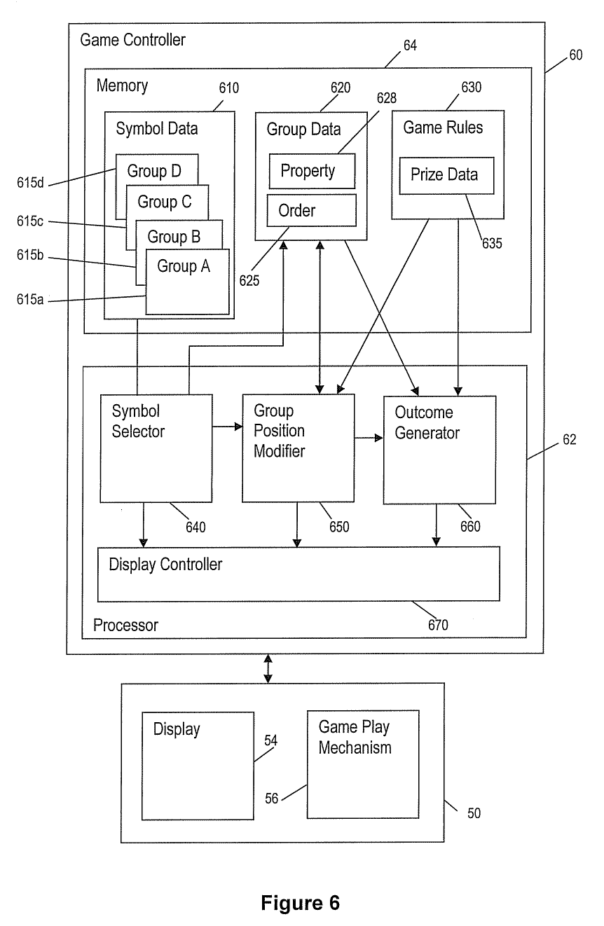

An embodiment of a gaming system is illustrated in FIG. 6. (Where possible the same numbering as FIG. 1 is used.) The gaming system comprises a gaming controller 60 and a player interface 50. The gaming controller 60 includes a processor 62 and memory 64. Functions implemented in the game controller include a symbol selector 640, a group position modifier 650, an outcome generator 660 and a display controller 670. The player interface includes a display 54 and game play mechanism 56.

The symbol selector 640 selects symbols from symbol data 610 which comprises a set of available symbols for each of a plurality of groups 615a-d. For example, each group 615a 615b 615c 615d may specify the configuration of one of a plurality of reels, and the symbol selector may be in the form of a reel controller for selecting stop positions for each reel. The symbol selector may also use group data 620 and in particular display order data 625 during set selection in some embodiments.

The display controller 670 is provided with data defining the symbols to display for each group by the symbol selector 640 and group display position data by the group position modifier 650, and displays the symbol set in accordance with this data on the display 54. Data may also be provided to the display controller by the outcome generator 660, for example to cause highlighting of prize winning combinations of symbols on the display 54.

The group position modifier 650 determines the initial and modified display positions for each of the groups. The group position modifier uses group data 620 stored in memory 64 when determining allowed group position modification actions. The group data 620 can include group order data 625, which determines where each group is to be displayed, and group properties 628, which can include control information for groups individually or collectively. For example, individual group property values can control eligibility for modification or whether symbols for the group are to be held in position for a symbol selection operation. Collective group control information can include information such as the number of groups allowed to be modified for a game and whether group position modification comprises a shuffle or a swap.

Group order data 625 may be predefined before selecting an initial set of symbols. The group position modifier controls the modification of group positions in accordance with game rules and updates the group order data 615 accordingly. Depending on the specific embodiment, the group position modifier may provide one or more of the following functions:
selecting one or more groups to modify position for;
selecting the modified position for a selected group;
determining any subsequent group position modifications necessitated by a group modification, such as groups to shuffle into subsequent positions;
updating any property values in the group data; and
sending data to the display controller to cause it to update the displayed set of symbols after group position modifications.

In an embodiment of the invention modifying the position of one group causes a “shuffle” of other groups to accommodate the modified set within the same display window as the initial set. In this embodiment the group position modifier increments the display positions of groups between a first position and a second position, where the first position is where the modified group is selected from and the second position is the modified display position for the selected group. Thus the groups appear to shuffle to accommodate the modified group in its new display position. In this embodiment the display controller may use an animation technique to show the “shuffle” to enhance the visual interest to the player.

In another embodiment modifying the display position comprises a swap of the display position of two groups. In this embodiment a first group position and a second group position are selected and exchanged by the group position modifier such that the first group symbols will be displayed in the second position and the second position symbols displayed in the first position in the revised set.

In an embodiment where the player is allowed some control over the group modification, the group position modifier 650 can also be provided with data regarding a player's group modification selection from the game play mechanism 56. For example, the player may select which group is to be modified, a destination position for a modified group, or whether the display position modification is performed as a swap or shuffle.

The outcome generator 660 uses the selected symbol set and group display positions when determining game outcomes. Depending on the embodiment, the outcome generator determines based on the game rules 630 and the prize data 635 whether a game outcome (e.g. an award of credits) should be generated based on the positions of symbols displayed on display 54. In some embodiments the game outcome may be determined after all allowed group position modifications have been completed or intermediate outcomes may be determined, say for each group position modification.

A player's eligibility for the group display position modification feature can be determined in accordance with any known eligibility rule including but not limited to:
the feature being available to all players for all bets;
the feature being available for certain bets only, different levels of the game being available for different bets. For example, standard bets are entitled to modification of one group's display position, additional bets are entitled to additional group display position modifications.

The commencement of the feature can be in accordance with any of the known rules including but not limited to:
commencing when a symbol or a combination of symbols appear in the window;
commencing when a time has elapsed;
commencing when a turnover has elapsed;
commencing when a system event occurs or commencing when a game event occurs such as an underlying random event.

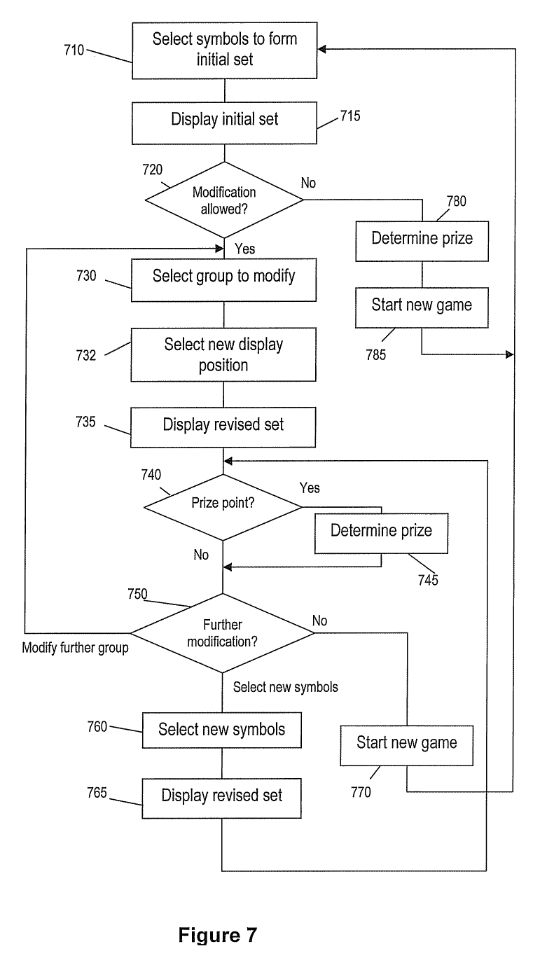

FIG. 7 illustrates a game process using a flowchart. A game starts with the selection of an initial symbol set 710 which is displayed 715 for the player. The game controller determines whether the criteria for the group display position modification feature have been met 720. If the position modification is not allowed then a game outcome is determined based on the initial set 780 and initialisation for a new game 785 performed.

If the group display position feature is enabled, then the group to modify is selected 730 and the new display position is selected 732 to form a revised set. The group to modify and new position may be selected by the player, or the game controller depending on the implemented game rules. The revised set is then displayed 735 to the player. Whether or not a game outcome is determined 740 is based on game rules. If a prize is to be determined on the revised set the outcome generator will perform the prize determination 745 before the game continues.

Further modification may be allowed 750 based on game rules. The further modification can involve selecting a further group for display position modification, and in this case steps 730 to 750 are repeated.

Alternatively a further modification can comprise modifying the symbols in one or more groups by performing a further symbol selection step 760 and displaying a further revised set 765. The game process can loop back to step 740 to determine whether to perform a prize determination 745 and perform further modification 750 or start a new game 770.

In an embodiment a modified group is held, such that the displayed symbols do not change, and a further symbol selection performed for the remaining groups 760 to form a further revised set for display 765. This process can be repeated until an end condition is met, such as a prize awarded or all groups having been moved.

Alternatively symbols for the group having the modified display position (or another selected group) may be altered without changing the symbols of other groups. For example a new selection process may be performed for the group or another action such as a “nudge” may be performed.

The process of forming further revised sets and determining game outcomes can be repeated until an end condition is met.

Various modifications to the above embodiment and following examples will be apparent to the person skilled in the art and are considered within the scope of the present invention. For example embodiments may be implemented using horizontally spinning reels where the display position for a reel is modified vertically. Embodiments may be implemented where the symbols are not represented as part of reels, for example the symbols may be represented as groups of dice, groups of coloured or numbered balls from barrels, groups of fish caught in nets etc.

Alternatively, a mechanical embodiment of the invention may be implemented using physical reels or containers of symbols such as buckets of balls. In this embodiment the reels or buckets are physically moved to form the revised set. In such an embodiment watching the physical movement can provide further entertainment for the player.

It will be understood to persons skilled in the art of the invention that many modifications may be made without departing from the spirit and scope of the invention, in particular it will be apparent that certain features of the invention can be combined to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### EXAMPLE 1

A five by three spinning reel game is being played at one credit per line and five lines. The game has three pay lines running horizontally across the screen. Pay line 801 runs through the centre of the symbol display matrix 800. Pay line 802 runs through the five symbols in the top line of the matrix and pay line 803 runs through the five symbols in the bottom line of the matrix. There are five symbol groups 811 to 815, each group corresponding to one reel, such that one symbol from each group makes up each pay line.

The player is able to place bets to cover prize patterns on lines 801, 802 or 803. Prizes are paid whenever the symbols shown on a pay line match a prize pattern. In this example all prize patterns require the symbols to be aligned from left to right. For example, three queens adjacent each other on a single purchased pay line pays 5 credits. The example shown also includes a “wild” symbol which substitutes for all other symbols.

In this example the eligibility criteria to modify the display position of a reel includes a “wild” symbol appearing on a reel and a player has payed an additional bet. In this case when these criteria are met the player is eligible to modify the display position of the reel bearing the “wild” symbol.

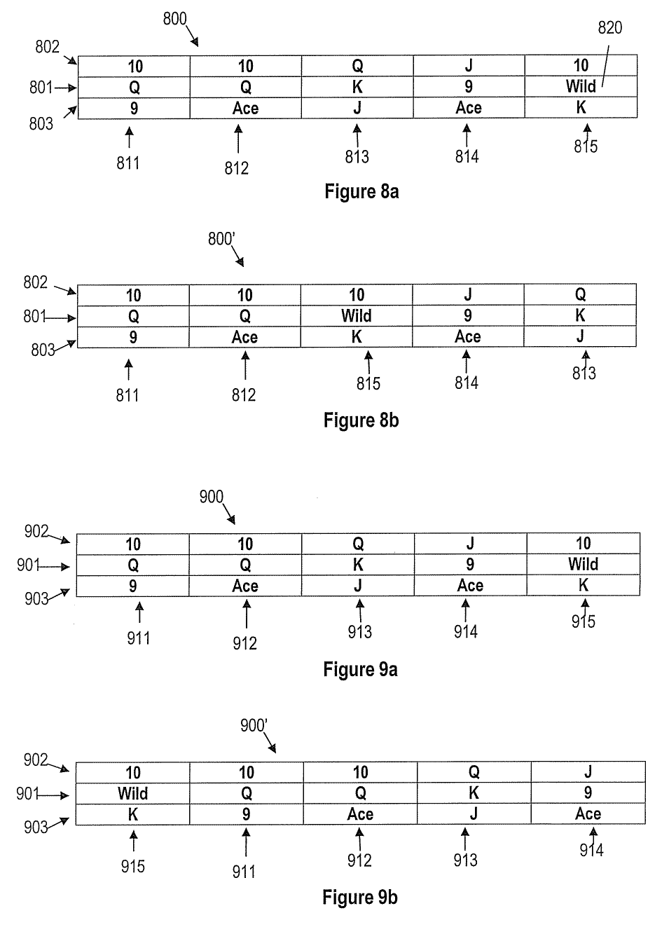

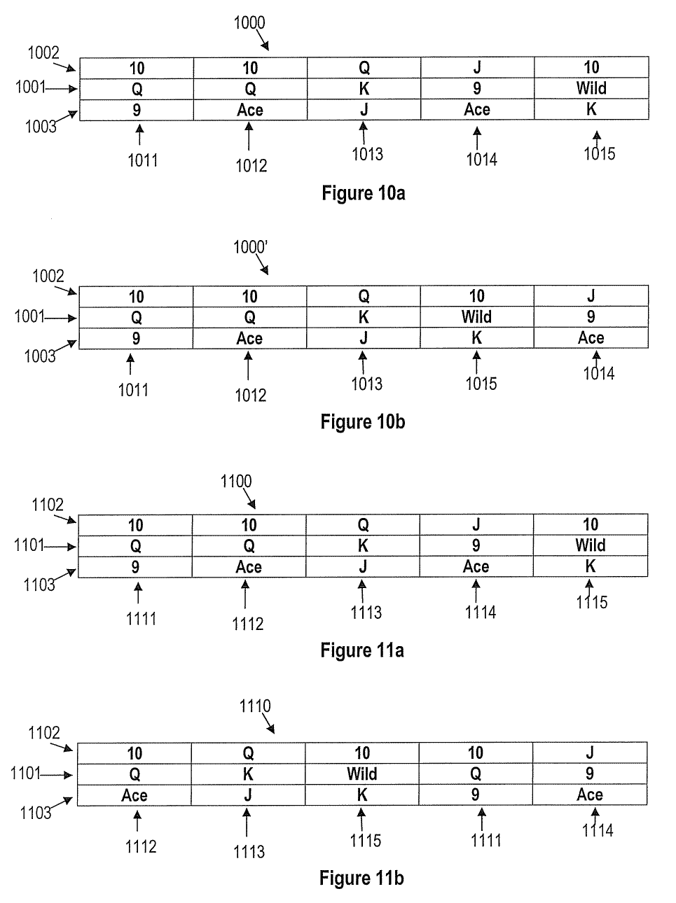

FIG. 8a illustrates a displayed initial set 800. In this case, the player has placed a bet to buy all three pay lines 801, 802, 803 and the right to modify a group's display position. The reels spin for symbol selection and after they stop the initial set displayed is shown in figure 8a. The result of this spin is that no winning combinations in the initial set displayed 800. However, as there is a “wild” symbol 820 in group 815 and the player has purchased the right to modify a group position, the position of group 815 is eligible for modification.

The player can be asked to press a button to confirm the use of the position modification feature or the group modification may be performed automatically by the game controller.

In this example the game controller determines the optimal location where the eligible group 815 should be moved to maximise the prize payable and swaps the eligible reel 815 with the reel at the optimal position 813 to provide the revised set 800′ as shown in FIG. 8b.

In this case group 815 is swapped with group 813 to form the revised set 800′. The symbols now showing in the window are evaluated for a prize. There are two prize winning patterns showing. The first winning pattern is the three “10” symbols in line 802. The second winning pattern is formed from two “Q” symbols and one “wild” symbol in line 801. Each of these winning patterns is formed of symbols of groups 811, 812, and 815.

The prize is paid and the game returns to normal play.

### EXAMPLE 2

This example is similar to the game of Example 1, however, in this example the game controller determines at random where the eligible reel shall be moved to and moves along or “shuffles' the other reels.

The reels are spun to form an initial set 900 having no prize winning symbol patterns. However there is a “wild” symbol in group 915 and the player paid for the group position modification feature so group 915 is eligible to be moved. The player can be asked to confirm the group modification by the game controller.

In this example the position to move group 915 to is randomly determined by the game controller. For example the game controller can use the random number generator to select a new display position for group 915. In the illustrated example the display position selected is the first display position. The group 915 is move to the first display position and the remaining groups 911, 912, 913 and 914 are moved in order by one display position, so these remaining groups are “shuffled” to accommodate the moved group in the modified position in the revised set 900′.

In the revised set 900′ there are two prize winning patterns. The first prize winning patter is three adjacent “10” symbols in line 902. The second prize winning pattern is the two “Q” symbols and one “wild” symbol in line 901. The prize is then paid and the game returns to normal play.

### EXAMPLE 3

This example uses the same game as Example 2, where the game controller determines at random where the eligible reel shall be moved to and moves along or “shuffles' the other reels.

The reels are spun to form an initial set 1000 having no prize winning symbol patterns. However there is a “wild” symbol in group 1015 and the player paid for the group position modification feature so group 1015 is eligible to be moved. The player can be asked to confirm the group modification by the game controller.

In this example the position to move group 1015 to is randomly determined by the game controller. In the illustrated example the display position selected is the fourth display position. The group 1015 is move to the first display position and group 1014 is moved along one display position to form the revised set 1000′.

In the revised set 1000′ there are no prize winning patterns, so no prize is paid and the game returns to normal play.

### EXAMPLE 4

A five by three spinning reel game is being played and the payer is eligible for 3 free games. The eligibility for the free games may be a random event, such as a bonus granted randomly by the game controller, based on game rules, such as a cumulative spend by a player or for a machine, or a form of prize awarded from a game.

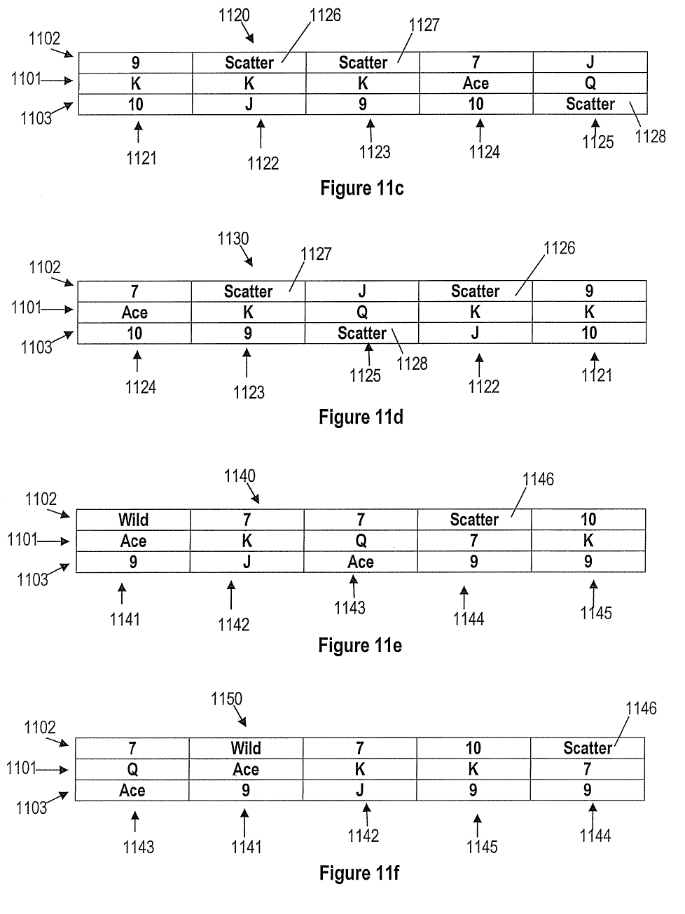

FIGS. 11a to 11f illustrate the displayed symbols for the three free games. The player is eligible for all three pay lines 1101, 1102 and 1103 for the free games. Each free game comprises one spin to form an initial set and a group position modification where the display positions of all groups are randomly modified by the game controller.

Prizes are paid whenever the symbols shown on a pay line match a prize pattern. In this example all prize patterns require the symbols to be aligned from left to right. For example, three queens adjacent each other on a single pay line pays 5 credits. The example shown also includes a “wild” symbol which substitutes for all other symbols and a special “scatter” symbol which only needs to appear in the displayed symbol set to win a prize, and a prise is awarded for each scatter symbol.

FIG. 11a illustrates a displayed initial set 1100 for a first free game. There are no winning combinations in the initial set displayed 1100 where groups 1111, 1112, 1113, 1114 and 1115 are in the first, second, third, fourth and fifth display positions respectively.

The game controller then modifies the display positions of each group to form a revised set 1110 as shown in FIG. 11b. In the revised set 1110 group 1111 is moved to the fourth display position, group 1112 to the first display position, group 1113 to the second display position, group 1114 to the fifth display position and group 1115 to the third display position. Thus the display positions of all groups have been modified. However, no prize winning patters are present in the revised set 1110 so no prise is payable.

FIG. 11c shows the result when the reels are then spun for the second free game and symbols selected an displayed as initial set 1120 having groups 1121, 1122, 1123, 1124 and 1125 in the first, second, third, fourth and fifth display positions respectively. The initial symbol set 1120 has a prize winning pattern the three “K” symbols in pay line 1101. Further the initial symbol set includes three special “scatter” symbols 1126, 1127 and 1128 and a prize is awarded for each occurrence of a “scatter” symbol in a set, regardless of its displayed position.

Once the prizes payable for the initial set are paid the game controller modifies the group display positions to form a revised set 1130 as shown in FIG. 11d. In the revised set 1130 all the group display positions have been modified with group 1121 is moved to the fifth display position, group 1122 to the fourth display position, group 1123 to the second display position, group 1124 to the first display position and group 1125 to the third display position. In this revised set 1130 there are no longer any prize winning patterns of symbols displayed, so no further prize is payed based on symbol patterns. However, as the three “scatter” symbols still appear, a prize is paid for each of the “scatter” symbols. The prizes are paid and the second free game ends.

FIG. 11e shows the result when the reels are then spun for the third, and final, free game and symbols selected an displayed as initial set 1140 having groups 1141, 1142, 1143, 1144 and 1145 in the first, second, third, fourth and fifth display positions respectively. The initial symbol set 1140 has a prize winning pattern of two “7” symbols and one “wild” symbol in pay line 1102. Further the initial symbol set 1140 includes one special “scatter” symbol 1146 so a prize is also awarded for the “scatter” symbol.

Once the prizes payable for the initial set 1140 are paid the game controller modifies the group display positions to form a revised set 1150 as shown in FIG. 11f. In the revised set 1150 all the group display positions have been modified with group 1141 moved to the second display position, group 1142 to the third display position, group 1143 to the first display position, group 1144 to the fifth display position and group 1145 to the fourth display position. In this revised set 1150 there is a prize winning patterns of symbols in the two “7” symbols and one “wild” symbol displayed adjacent each other in pay line 1102, so a further prize is payed based on the symbol patterns. Also a further prize is paid for the “scatter” symbol. The prizes are paid and the third and final free game ends, and the game controller returns to normal game play.

1. A method of gaming comprising:
displaying an initial set of symbols comprising symbols of a plurality of groups in respective ones of display positions; and
forming a revised set of symbols by modifying the display position of symbols of at least one group relative to at least one other group of the plurality of groups.

2. A method as claimed in claim 1 wherein, each group of symbols is selected from a predetermined set of symbols representing a reel of symbols.

3. A method as claimed in claim 2 wherein a reel of symbols is representative of symbols in a given order drawn on a physical looped reel.

4. A method as claimed in claim 2 wherein each reel is implemented in software as a virtual reel of symbols.

5. A method as claimed in claim 4 wherein one or more symbols from each reel are selected for display based on symbol selection algorithm.

6. A method as claimed in claim 5 wherein the symbol selection algorithm imitates displaying one or more consecutive symbols based on a stop position of each reel.

7. A method as claimed in claim 1 further comprising the step of determining a game outcome based on the relative position of symbols within the revised set of symbols.

8. A method as claimed in claim 1 further comprising the step of forming a further revised set by modifying the display position of a further group relative to at least one other group of the plurality of groups.

9. A method as claimed in claim 8 wherein the step of forming further revised sets is repeated until an end condition is met.

10. A method as claimed in claim 8 further comprising a step of determining a game outcome based on relative positions of symbols within the further revised set of symbols.

11. A method as claimed in claim 1 further comprising the step of forming a further revised set by altering the symbols displayed within one group.

12. A method as claimed in claim 11 wherein altering the symbols displayed in one group comprises incrementally shifting the symbol display position of symbols within the group such that one symbol ceases to be displayed at one end of a group display area and a further symbol is selected and displayed at an opposing end of the group display area.

13. A method as claimed in claim 1 further comprising the steps of:
holding at least one group of symbols such that the symbols selected for display do not change; and
forming a further revised set of symbols by re-selecting symbols for the remaining groups.

14. A method as claimed in claim 13 wherein the held group of symbols is the group in the modified display position.

15. A method as claimed in claim 1 wherein the set of symbols includes a special function symbol provided with a special function.

16. A method as claimed in claim 15 wherein the special function symbol is arranged to remain in a fixed position when a further revised set is formed.

17. A method as claimed in claim 15 wherein the special function symbol is associated with a group and change display position with the group.

18. A method as claimed in claim 1 further comprising the step of determining a game outcome based on the initial set of symbols.

19. A method as claimed in claim 1 wherein modifying the display position of symbols comprises a swap where the display position of one group of symbols is swapped with the display position of another group of symbols.

20. A method as claimed in claim 1 wherein modifying the display position of one group of symbols comprises a shuffle, where altering the position of one group of symbols from a first position to a second position causes a subsequent shift by one display position of each group of symbols displayed between the first and second display positions.

21. A method as claimed in claim 1 wherein the group of symbols to have a modified display position is selected by the game player.

22. A method as claimed in claim 21 wherein the player selects the modified display position of the selected group.

23. A method as claimed in claim 1 wherein the modified display position of the selected group is determined by a game controller.

24. A method as claimed in claim 23 wherein modified display position is selected randomly.

25. A method as claimed in claim 23 wherein modified display position is selected based on predetermined game rules.

26. A method as claimed in claim 1 wherein groups to modify display positions for are selected by a game controller.

27. A method as claimed in claim 26 wherein the groups to modify display positions for are predetermined, randomly selected or selected based on pre-defined game rules.

28. A method as claimed in claim 1 wherein the number of groups allowed to be modified is predetermined, randomly selected or determined based on game rules.

29. A method as claimed in claim 1 wherein the group display position is modified until an end condition is met.

30. A method as claimed in claim 1 wherein eligibility for modifying a group display position for a game is based on eligibility criteria.

31. A method as claimed in claim 30 wherein eligibility criteria is based on game rules.

32. A method as claimed in claim 30 wherein eligibility is based on player activity.

33. A method as claimed in claim 1 implemented using physical spinning reels, wherein modifying the display position of a group comprises mechanically moving one or more reels.

34. A gaming system comprising:
a display;
a symbol selector arranged to select an initial set of symbols comprising symbols of a plurality of groups for display in respective ones of a plurality of group display positions;
a group position modifier arranged to modify the group display positions of one or more groups to form a revised set of symbols for display; and
a display controller arranged to cause the display to display the initial set and revised set of symbols based on group display positions.

35. A gaming system as claimed in claim 34 further comprising an outcome generator arranged to determine a game outcome based on the revised set of symbols.

36. A gaming system as claimed in claim 34 implemented as a stand alone gaming machine.

37. A gaming system as claimed in claim 34 implemented across a network.

38. A game controller comprising:
a symbol selector arranged to select an initial set of symbols comprising symbols of a plurality of groups for display in respective ones of a plurality of group display positions;
a group position modifier arranged to modify the group display positions of one or more groups to form a revised set of symbols for display; and
a display controller arranged to cause the display to display the initial set and revised set of symbols based on group display positions.

39. A game controller as claimed in claim 38 further comprising an outcome generator arranged to determine a game outcome based on the revised set of symbols.

40. Computer program code which when executed causes a computer to implement a computer implemented gaming method comprising:
displaying an initial set of symbols comprising symbols of a plurality of groups in respective ones of display positions; and
forming a revised set of symbols by modifying the display position of symbols of at least one group relative to at least one other group of the plurality of groups.
